(19) United States
(12) Patent Application Publication
(10) Pub. No.: US 2006/0144400 A1
(43) Pub. Date: Jul. 6, 2006

(54) Carrying device for a respirator product

(75) Inventor: Thomas Grassl, Lubeck (DE)

Correspondence Address: MCGLEW & TUTTLE, PC, P.O. BOX 9227, SCARBOROUGH STATION, SCARBOROUGH, NY, 10510-9227, US

(73) Assignee: Drager Safety AG & Co. KGaA, Lubeck (DE)

(21) Appl. No.: 11/259,655

(22) Filed: Oct. 26, 2005

(30) Foreign Application Priority Data
Dec. 22, 2004 (DE) 10 2004 061 661.2

(51) Int. Cl. A62B 9/00; A45F 3/08; A62B 7/00

(52) U.S. Cl. 128/205.22; 224/262; 128/202.27

(57) ABSTRACT

A carrying device for a respirator product shall be improved such as to ensure the greatest possible mobility for the carrier. To accomplish this object, shoulder supports (2, 3) made of a solid material are provided at the carrying belt.

### CROSS REFERENCE TO RELATED APPLICATIONS

This application claims the benefit of priority under 35 U.S.C. § 119 of German Application DE 10 2004 061 661.2 filed Dec. 22, 2004, the entire contents of which are incorporated herein by reference.

### FIELD OF THE INVENTION

The present invention pertains to a carrying device for a respirator product.

### BACKGROUND OF THE INVENTION

A carrying device for carrying loads on the back has become known from DE 299 19 705 U1. A rocker is fixed to a carrying plate on the back of a carrier in a height-adjustable and rotatably movable manner. The rocker has two belt fasteners on its top side for a one-piece carrying belt extending from the rocker back to the rocker via two eyelets on the underside of the carrying plate. The one-piece carrying belt has a favorable effect on the use of the carrying device, because the extension of one shoulder belt exactly corresponds to the shortening of the other shoulder belt and the carrying device is always in a uniformly firm contact with the carrier's back. Differences in the length of the back and torsional movements of the upper body are compensated with the rocker arranged in a height-adjustable and rotatably movable manner.

### SUMMARY OF THE INVENTION

The basic object of the present invention is to provide a carrying system with improved mobility for the carrier.

According to the invention, a carrying device is provided for a respirator product with a back plate and a rocker fastened to the back plate in a height-adjustable manner. A belt fastener and a second belt fastener are provided with a carrying belt extending from a first belt fastener via eyelets on the underside of the back plate to the second belt fastener. U-shaped shoulder supports made of a solid material are provided through which is led the carrying belt.

The shoulder supports are adapted to the shoulder and to the back of the carrier in a U-shaped pattern according to the present invention at the carrying belts. The shoulder supports consist of a solid material, preferably a hard plastic, so that they are lightweight, on the one hand, and can be deformed to a very limited extent only.

Compared to a shoulder support made of a flexible material, the subjective impression that the weight of the respirator product burdens the carrier's back is no longer created with the shoulder supports formed of a solid material. In addition, a greater distance can be better set between the carrier's back and the back plate of the carrying device with undeformable shoulder supports, which markedly increases the carrier's freedom of movement.

A carrying belt length adjustment means is advantageously provided for on the right-hand side of the belt only, because it can be operated in a simple manner there and a shortening of the length of the carrying belt on one side also affects the other side correspondingly.

The carrying properties are further improved when the shoulder supports are attached directly to the rocker. The carrying belts may be led now either through the shoulder support to the belt fasteners at the rocker or they are attached to the shoulder supports.

To further improve the carrying properties, a limiting stop, by which the shortening of the length of a shoulder belt is limited, especially when the carrying device is put on, is arranged at the carrying belt between the eyelets on the back plate through which the carrying belt is passed. The limiting stop may also be combined with the length adjusting means of the carrying belt.

The shoulder supports may advantageously contain fastening means for components of the respirator product. These components may be a pressure reducer or a pressure gauge for the cylinder pressure.

An exemplary embodiment of the present invention is shown in the drawings and will be explained in greater detail below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic exploded view showing the design of a carrying device according to the invention; and

FIG. 2 is side view showing the carrying device according to FIG. 1 in the assembled state.

### DESCRIPTION OF THE PREFERRED EMBODIMENT

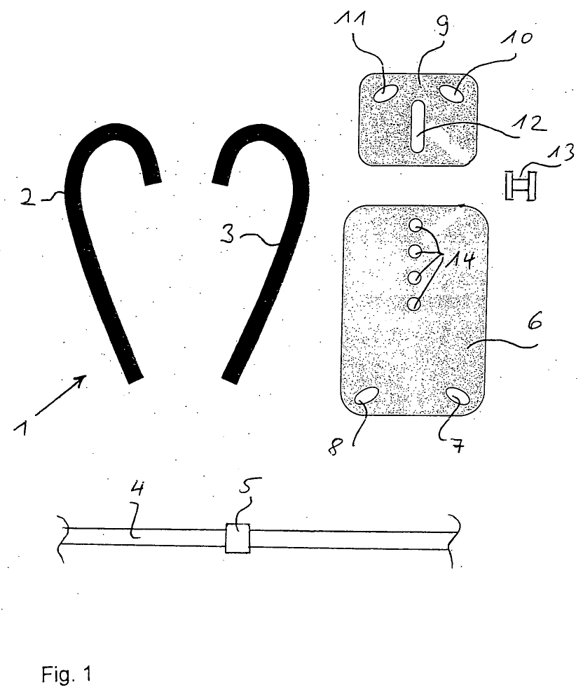

Referring to the drawings in particular, FIG. 1 schematically shows the design of a carrying device 1 for a respirator product that is supported on a back plate 6 and not shown more specifically. The carrying device contains as its components two shoulder supports 2, 3 made of a hard plastic, which are bent in a U-shaped pattern, a carrying belt 4 with a limiting stop 5, the back plate 6 with two eyelets 7, 8 for pulling through the carrying belt 4 and a rocker 9. The rocker 9 has a first belt fastener 10 and a second belt fastener 11 for the carrying belt 4 and an elongated hole 12 for receiving a bolt 13. The rocker 9 is connected to the back plate 6 via the bolt 13 in a rotatably movable manner. To adapt the carrying device 1 to different back lengths, different fastening points 14 are provided for the bolt 13 on the back plate 6.

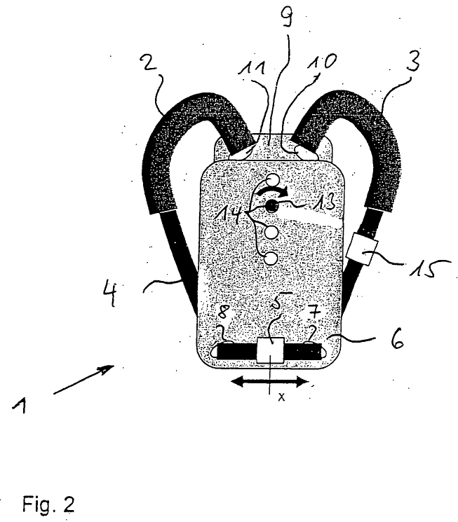

FIG. 2 shows the carrying device 1 in the assembled state. The carrying belt 4, which is led through the shoulder supports 2, 3, extends from the first belt fastening means 10 via the eyelets 7, 8 on the underside of the back plate 6 to the second belt fastener 11. The limiting stop 5 of the carrying belt 4 is located in the middle between the eyelets 7, 8, so that a length compensation can be performed between the right and left sides of the carrying belt by half the distance x of the eyelets 7, 8. The length of the carrying belt 4 can be changed by means of a strap buckle 15 on the right-hand side of the carrying device 1.

While a specific embodiment of the invention has been shown and described in detail to illustrate the application of the principles of the invention, it will be understood that the invention may be embodied otherwise without departing from such principles.

What is claimed is:

1. A carrying device for a respirator product, the carrying device comprising:
a back plate, the back plate having eyelets on an underside of said back plate;
a rocker date fastened to said back plate in a height-adjustable manner, the rocker plate having a first belt fastener and a second belt fastener;
a carrying belt extending from said first belt fastener via said eyelets to said second belt fastener;
U-shaped shoulder supports made of a solid material, each of said shoulder supports defining a passage through which is led the carrying belt.

2. A carrying device in accordance with claim 1, further comprising a length adjusting means connected to said carrying belt for adjusting a length thereof.

3. A carrying device in accordance with claim 1, wherein the shoulder supports are connected to the belt fasteners at the rocker.

4. A carrying device in accordance with claim 1, further comprising a limiting stop at the carrying belt disposed between the eyelets on the back plate.

5. A carrying device in accordance with claim 1, wherein the shoulder supports have fastening means for fastening components of the respirator product.

6. A carrying device for a respirator product, the carrying device comprising:
a back plate, the back plate having eyelets on an underside of said back plate;
a rocker plate fastened to said back plate in a height-adjustable manner, the rocker plate having a first belt fastener and a second belt fastener;
a carrying belt extending through said eyelets;
U-shaped shoulder supports made of a solid material, each of said shoulder supports being connect to said carrying belt with one said U-shaped shoulder supports or said carrying belt being connected to said rocker.

7. A carrying device in accordance with claim 6, further comprising a length adjusting means connected to said carrying belt for adjusting a length thereof.

8. A carrying device in accordance with claim 6, wherein the shoulder supports are connected to the belt fasteners at the rocker plate.

9. A carrying device in accordance with claim 6, further comprising a limiting stop at the carrying belt disposed between the eyelets on the back plate.

10. A carrying device in accordance with claim 6, wherein the shoulder supports have fastening means for fastening components of the respirator product.

11. A respirator carrying device comprising:
a back plate, the back plate having eyelets on an underside of said back plate;
a respirator connected to said back plate;
a rocker plate fastened to said back plate in a height-adjustable manner, the rocker plate having a first belt fastener and a second belt fastener;
a carrying belt extending from said first belt fastener via said eyelets to said second belt fastener;
U-shaped shoulder supports made of a solid material, each of said shoulder supports being connected to the carrying belt.

12. A carrying device in accordance with claim 11, further comprising a length adjusting means connected to said carrying belt for adjusting a length thereof.

13. A carrying device in accordance with claim 11, wherein the shoulder supports are connected to the belt fasteners at the rocker plate.

14. A carrying device in accordance with claim 11, further comprising a limiting stop at the carrying belt disposed between the eyelets on the back plate.

15. A carrying device in accordance with claim 11, wherein the shoulder supports have fastening means for fastening components of the respirator product.
